(19) United States
(12) Patent Application Publication
(10) Pub. No.: US 2015/0204278 A1
(43) Pub. Date: Jul. 23, 2015

(54) COMPRESSOR WHEEL OF THE COMPRESSOR OF AN EXHAUST-GAS TURBOCHARGER

(71) Applicant: BorgWamer Inc., Auburn Hills, MI (US)

(72) Inventor: Aleksandar Sekularac, Worms (DE)

(21) Appl. No.: 14/420,070

(22) PCT Filed: Jul. 31, 2013
(86) PCT No.: PCT/US2013/052864

§ 371 Date: Feb. 6, 2015

(30) Foreign Application Priority Data
Aug. 13, 2012 (DE) 102012016028.3

(51) Int. Cl. F02M 25/07; F01D 5/14

(52) U.S. Cl. CPC F02M 25/071; F01D 5/14

(57) ABSTRACT

A compressor wheel (1) of a compressor (6A) of an exhaust-gas turbocharger (6), having a hub (2); and having a multiplicity of non-recessed blades (3) which are arranged on the hub (2) and which have in each case a blade leading edge (3A) and a blade trailing edge (3B). The blade leading edges (3A) define an inlet area (A₁) which is the area swept by the blade leading edges (3A) as the compressor wheel (1) rotates. The blade trailing edges (3B) define an outlet area (A₂) which is the area swept by the blade trailing edges (3B) as the compressor wheel (1) rotates. The ratio A₂/A₁ is >60%.

The invention relates to a compressor wheel of the compressor of an exhaust-gas turbocharger, as per the preamble of claim 1.

A so-called two-stage supercharger device for internal combustion engines comprises two turbochargers of different size which are connected in series. Here, the smaller turbocharger is the high-pressure exhaust-gas turbocharger, whereas the larger exhaust-gas turbocharger is the low-pressure exhaust-gas turbocharger.

This type of two-stage supercharging has the advantage that the two separate compressor stages must in each case generate only a part of the overall pressure increase of the overall system.

It is an object of the present invention to provide a compressor wheel of a compressor of an exhaust-gas turbocharger, the compressor wheel geometry of which is optimized.

This object is achieved by the features of claim 1.

By virtue of the fact that the ratio between the inlet area and the outlet area of the compressor wheel according to the invention is set to values greater than 60%, particularly advantageous effects are attained for usage with the two-stage supercharging systems explained above. The use of the compressor wheel according to the invention is however not restricted to two-stage supercharging systems, because a lower compressor pressure ratio can be used also in single-stage systems.

Claim 3 defines an exhaust-gas turbocharger according to the invention as an independent marketable product.

Further details, advantages and features of the present invention become apparent from the following description of exemplary embodiments with reference to the drawing, in which:

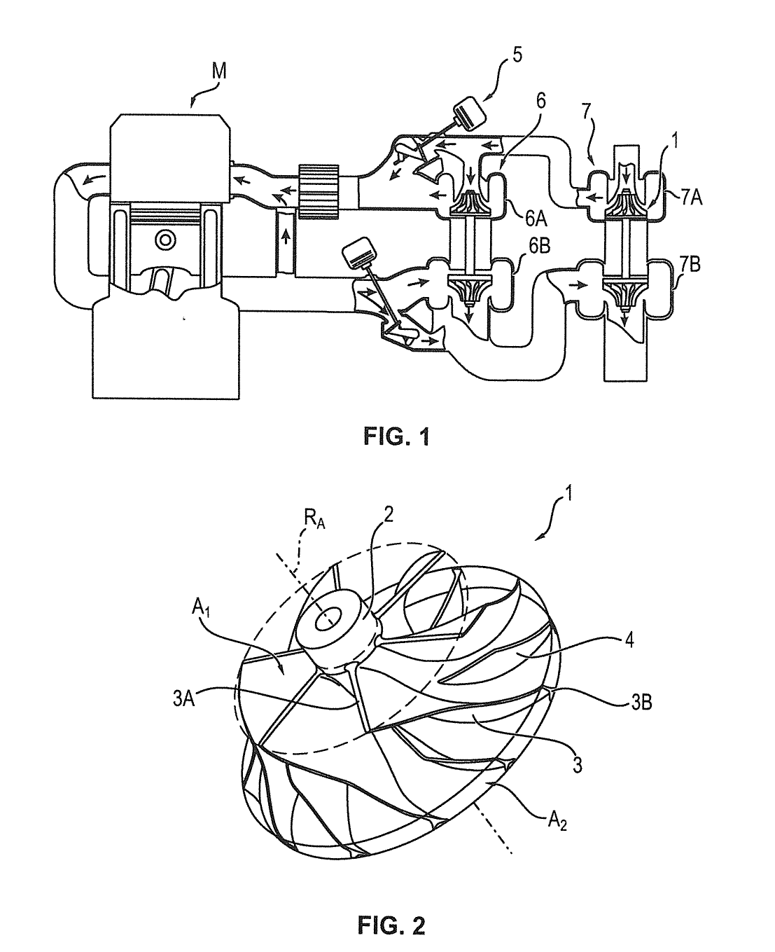

FIG. 1 is a schematic illustration of a two-stage supercharging system, and

FIG. 2 is a perspective illustration of a compressor wheel according to the invention.

FIG. 1 is a schematic illustration of a two-stage supercharging device 5 for an engine M, which is indicated symbolically by one of the cylinders thereof. The two-stage supercharging device 5 has two exhaust-gas turbochargers 6 and 7 connected in series. The turbocharger 6 constitutes the high-pressure exhaust-gas turbocharger with associated compressor 6A and associated turbine 6B.

The exhaust-gas turbocharger 6 is the high-pressure exhaust-gas turbocharger with associated compressor 6A and associated turbine 6B. The compressor wheel 1 according to the invention is, by way of example, the compressor wheel of the described high-pressure compressor 6A, and will be explained in detail below on the basis of FIG. 2.

The compressor wheel 1 has a hub 2. On the hub 2 there is arranged a multiplicity of non-recessed blades, of which one blade is indicated, representatively for all of the blades, by the reference numeral 3. In the example, six such blades 3 are provided. Between the non-recessed blades 3 there are arranged recessed blades 4, also referred to as “splitter blades”.

FIG. 2 shows that the blades 3 have in each case a leading edge 3A and a trailing edge 3B. Here, the blade leading edges 3A define an inlet area A₁ which is the area swept by the blade leading edges 3A as the compressor wheel 1 rotates. As shown in FIG. 2, said inlet area A₁ is perpendicular to the axis of rotation R_{A}.

The blade trailing edges 3B of the non-recessed blades 3 define an outlet area A2 which is the area swept by the blade trailing edges 3B as the compressor wheel 1 rotates. This yields, as shown in FIG. 2, a cylindrical surface which, as per the above definitions, constitutes the “normalized” blade height at the outlet of the compressor wheel 1, which can also be referred to as the “tip height” and which is independent of the compressor wheel size and configuration.

According to the invention, the ratio A₂/A₁ is configured to values of >60%.

In addition to the above written disclosure of the invention, reference is hereby explicitly made to the diagrammatic illustration of the invention in FIGS. 1 and 2 for additional disclosure thereof.

### LIST OF REFERENCE SIGNS

1 Compressor wheel
2 Hub
3 Non-recessed blades
4 Recessed blades
5 Two-stage supercharging device
6 High-pressure exhaust-gas turbocharger
6A High-pressure compressor
6B High-pressure turbine
7 Low-pressure exhaust-gas turbocharger
7A Low-pressure compressor
7B Low-pressure turbine
A₁ Inlet area
A₂ Outlet area
R_{A} Axis of rotation
M Engine

1. A compressor wheel (1) of a compressor (6A) of an exhaust-gas turbocharger (6), having
a hub (2); and
a multiplicity of non-recessed blades (3) which are arranged on the hub (2) and which have in each case a blade leading edge (3A) and a blade trailing edge (3B),
wherein the blade leading edges (3A) define an inlet area (A₁) which is the area swept by the blade leading edges (3A) as the compressor wheel (1) rotates, and
wherein the blade trailing edges (3B) define an outlet area (A₂) which is the area swept by the blade trailing edges (3B) as the compressor wheel (1) rotates,
wherein
the ratio A₂/A₁ is >60%.

2. The compressor wheel (1) as claimed in claim 1, wherein the compressor wheel is the compressor wheel of a high-pressure exhaust-gas turbocharger (6) of a two-stage supercharging device (5).

3. The compressor wheel (1) as claimed in claim 1, wherein the compressor wheel is the compressor wheel of a low-pressure exhaust-gas turbocharger (7) of a two-stage supercharging device (5).

4. An exhaust-gas turbocharger (6) having a compressor (6A) which has:
a compressor wheel (1) with a hub (2) and with a multiplicity of non-recessed blades (3) which are arranged on the hub (2) and which have in each case a blade leading edge (3A) and a blade trailing edge (3B),
wherein the blade leading edges (3A) define an inlet area (A₁) which is the area swept by the blade leading edges (3A) as the compressor wheel (1) rotates, and
wherein the blade trailing edges (3B) define an outlet area (A₂) which is the area swept by the blade trailing edges (3B) as the compressor wheel (1) rotates,
wherein
the ratio A₂/A₁ is >60%.
